(19) United States
(12) Patent Application Publication
(10) Pub. No.: US 2019/0079786 A1
(43) Pub. Date: Mar. 14, 2019

(54) SIMULATION ENVIRONMENT CREATION

(71) Applicant: ENTIT SOFTWARE LLC, SANFORD, NC (US)

(72) Inventors: Inbar SHANI, Yehud (IL); Jonathan TARAGIN, Yehud (IL); Eli MORDECHAI, Yehud (IL)

(21) Appl. No.: 16/082,422

(22) PCT Filed: Mar. 7, 2016
(86) PCT No.: PCT/US2016/021137

§ 371 Date: Sep. 5, 2018

(51) Int. Cl. G06F 9/455; G06F 11/34

(52) U.S. Cl. CPC G06F 9/455; G06F 11/3414; G06F 11/3457

(57) ABSTRACT

Example implementations relate to creating a simulation environment. For example, a system for simulation environment creation may include a system controller. The system may also include a functional agent coupled to and executed by the system controller to create a simulation environment based on input comprising real user data and sensor data continuously received from a plurality of sources, perform tests within the simulation environment, continuously react to events occurring during the tests within the simulation environment, and continuously verify results of the tests.

### BACKGROUND

Computing systems may serve a plurality of input sources and output channels. Functional correctness, referring to a determination of whether the computing system and/or instructions perform as expected, may not be limited to a single user experience. Such computing systems may be verified with a plurality of users behaving in various manners, and in various environments.

### BRIEF DESCRIPTION OF THE DRAWINGS

FIG. 1 is a block diagram of an example system for simulation environment creation consistent with the present disclosure.

FIG. 2 is a block diagram of an example system for simulation environment creation consistent with the present disclosure.

FIG. 3 illustrates an example method for simulation environment creation consistent with the present disclosure.

### DETAILED DESCRIPTION

Modern computing systems and applications may adopt technologies that shift from a symmetric user experience to a varying user experience. As used herein, a symmetric user experience refers to an output that is the same for all users of the system, whereas a varying user experience refers to an output that may vary from one user to the next. An example may include navigational applications. Navigational applications may provide road navigation services to drivers by tracking global positioning service (GPS) data from mobile devices used by other drivers. Each user of the navigational application may receive different navigation recommendations within the same conditions, as the behavior of other drivers affect traffic and in turn affect the navigational application. The driver may or may not act as recommended by the navigational application, and in doing so may further affect traffic. Such navigational applications may be enhanced with further input sources such as police reports of accidents and roadblocks, and/or traffic volume reports from sensors mounted on traffic lights. These sources may affect and may be affected by the navigational application and may further be constrained by each other.

To test a computing system for functional correctness, varying input and output sources for the system may be simulated. Without simulation of the varying input and output sources, an application may produce trivial results. When testing a system under test (e.g., using functional testing with load conditions) a plurality of functional agents may be used to simulate real input sources of the system under test. However, some approaches may include functional agents (e.g., manual or automated scripts for functional testing) that do not represent multiple types of input behaviors and that run sequentially.

In contrast, simulation environment creation, consistent with the present disclosure, includes functional agents that may represent a plurality of types of input behaviors such as real user and sensor input and may run continuously. As used herein, continuously running may include running as the functional testing with load conditions is running without a pre-ordained start/stop time. The functional agents may also respond to events outside of their immediate interaction with the system under test interface (e.g., react to conditions imposed by a system controller). The functional agents may also include capabilities including being configurable by testers, increasing substantial volume to create load conditions, capturing and reporting on their status and the system under test status, etc.

As used herein, a functional agent refers to instructions to execute a particular configuration of events in a system (e.g., a system under test). The functional agents may be autonomous, such that they act independently of one another. The functional agents may be executed by a system controller and may be of varying types and behaviors. In some examples, the functional agents may be event-driven and may be created and configured by testers out of a repository of templates, provided with action conditions and script or visual actions, and executed by a system controller in a continuous fashion, reacting to a functional testing with load conditions environment. The functional agents may collectively simulate a particular condition and/or series of events within a system under test, in some instances.

In some examples, simulation environment creation, consistent with the present disclosure, may allow for the adaptation of these functional agents and the capture, diagnoses, and measurement of experience behavior of a system, in addition to embedding verifications and monitoring capabilities in the functional agents. Examples of the present disclosure may include functional testing (verifying a correct behavior of a system) while creating load conditions (e.g., escalating a plurality of functional agents performing different actions within the system).

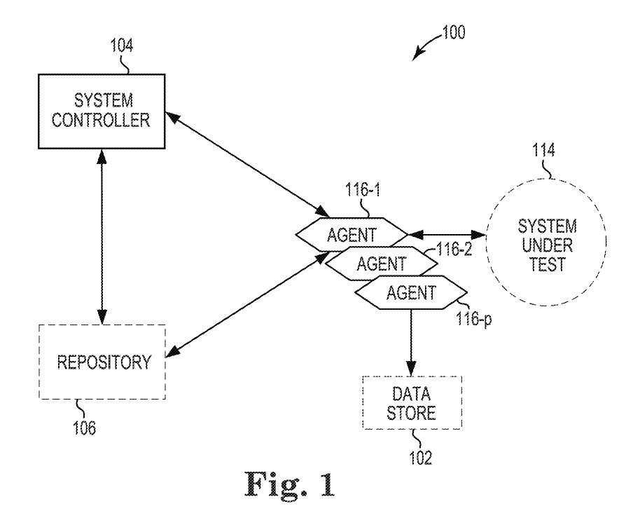

FIG. 1 is a block diagram of an example system 100 for simulation environment creation consistent with the present disclosure. System 100 may create, run, and report on autonomous event-driven functional agents as part of functional testing with load conditions. In some examples, the functional agents may use an event loop with some randomness in order to be autonomous.

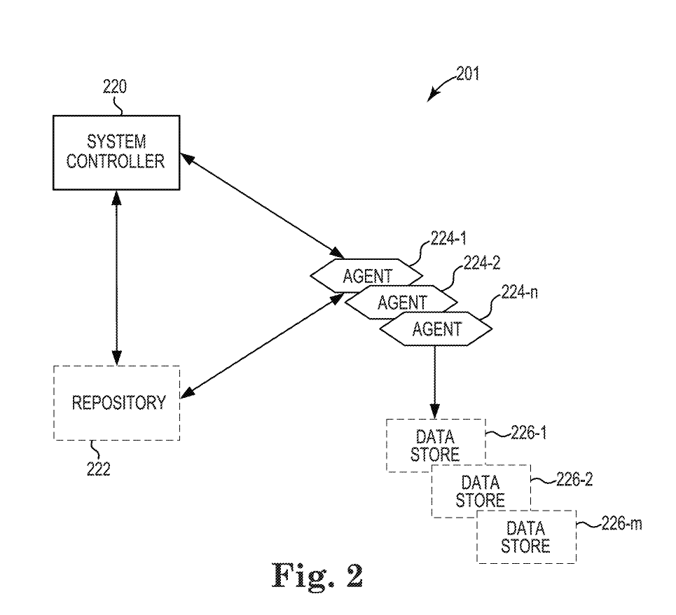

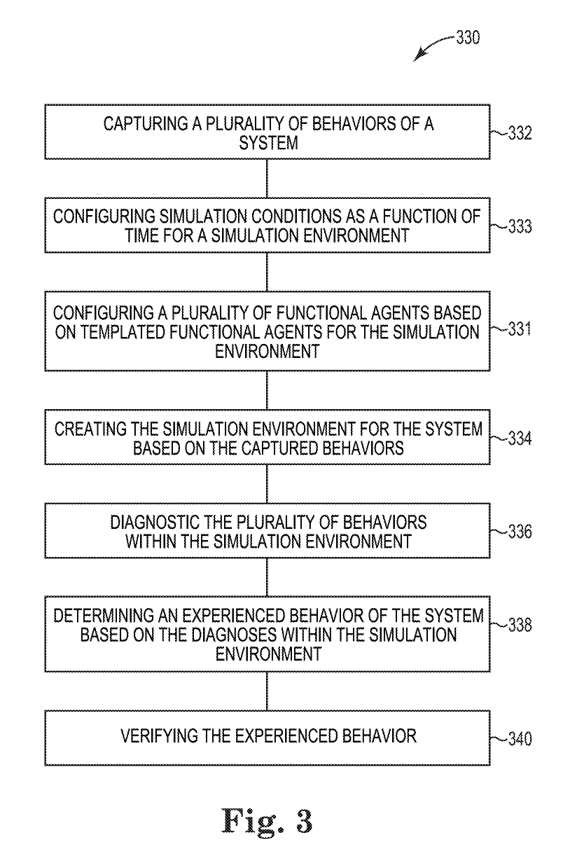

The system 100 may include a system controller 104 and a plurality of functional agents 116-1, 116-2, . . . , 116-p (referred to herein collectively as 116). The plurality of functional agents 116 may be autonomous, and in some examples, may be executed by the system controller 104 to perform a plurality of operations. The system 100 may also include, in some examples, an agent repository 106, a data store 102, and a system under test 114. The system 100 may include additional or fewer components than illustrated to perform the various operations as will be described in further detail in connection with FIGS. 2 and 3.

The components of system 100 may include a combination of hardware and programming, but at least hardware, that is configured to perform operations described herein stored in a memory resource (e.g., computer-readable medium, machine-readable medium, etc.) as well as hard-wired program (e.g., logic). For example, the system controller 104 may include hardware and/or a combination of hardware and programming, but at least hardware, to execute functional agents 116.

The functional agent may be instructions to execute a plurality of functions. For instance, each of the plurality of functional agents 116 may include instructions executed by system controller 104 to create a simulation environment to simulate system behavior based on input comprising real user data and sensor data continuously received from a plurality of sources. This is in contrast to other approaches, which may only simulate user interaction.

For instance, different types of users and inputs may provide information to the system. Real user data may include data from user input (e.g., via mobile and web applications), and/or data collected about the real users. This data may vary based on the user. For example, a user may choose to disregard directions given by a GPS (e.g., go left when told to go right) or refuse to pick up a passenger (e.g., a ride-sharing service driver refusing service). This real user input may be considered during creation of the simulation environment.

In contrast, sensor input may include input collected by objective sensors or other collection devices. For instance, sensor input may include data collected from a weather sensor or traffic sensor, among others. In some instances, system 100 may create a simulation environment that simulates different behaviors (e.g., real user, sensor, etc.) and creates interactions between those behaviors that are dependent on the flow of the system.

In some examples, the plurality of functional agents 116 may comprise particular action conditions, script actions, and visual actions. The plurality of functional agents, in some instances may include predicted and pseudo-predicted agents. Functional agent actions may be visual (e.g., non-script) or scripted series of stages that take as input event arguments, have access to a functional testing with load conditions environment, and may interact with a system under test as needed. Functional agent actions may output a plurality of types of data, which may subsequently be directed by system controller 104 to subscribed running functional agents. Functional agent actions may fire functional testing with load conditions built-in or custom events.

The plurality of functional agents 116 may also include instructions executed by system controller 104 to perform tests within the simulation environment and continuously react to events occurring during the tests within the simulation environment. The simulation environment may include test conditions created to deal with the environment conditions including real user and sensor data. For instance, in the case of a ride-sharing application, the simulation environment may include driver information, passenger information, and sensor information (e.g., traffic control, locations, weather, etc.).

Test conditions may be created in the simulation environment, and tests may be completed in the same environment. System controller 104 may invoke and simulate a situation and the plurality of functional agents 116. During this simulation and testing, conditions may be found and reported.

The plurality of functional agents 116 may be defined by a script and the events to which it can continuously react. As used herein, continuously includes without meaningful breaks. In some examples, circumstances may cause intermittent gaps between reaction (due to gaps in testing, etc.), and continuous should be read to include reactions with intermittent or periodic gaps, whether planned or unplanned. The script may be a non-one-directional script in that it may not start execution until it ends execution. Rather, it may be a series of events correlated with mini-scripts and/or script behavior, as well as running its own scripts. As a result, the plurality of functional agents 116 may continuously react to events triggered during system testing. The script, which may stimulate or drive an application or behavior, may allow for reactions. This is in contrast to other approaches, which follow a script in a particular order or manner, for example.

For instance, in the example of a ride-sharing application, a driver refusing to pick up a requesting passenger may result in the plurality of functional agents 116 reacting to that event by adjusting simulation based on the real user input of that driver not picking up a requesting passenger. This real user behavior may differ from another driver's behavior. In such an example, system 100 may allow for the creation of these and other different behaviors while testing, and may still synchronize everything that is happening.

In some examples, the plurality of functional agents 116 may define the events to which they react. For instance, the events may be template events, such that there may be some variation in the exact event occurrence. In such an example, when an event arises, there may be an associated script that dictates how a functional agent within the plurality of functional agents 116 may simulate the real user and sensor input data.

The plurality of functional agents 116 may also include instructions executed by system controller 104 to continuously verify results of the tests. For instance, results of tests within the simulation environment may be verified using rules. Following these rules, a test may be given a pass, fail, or other indication of performance. The verifications may be constantly executed by the functional agents, as opposed to following a particular sequence of actions.

In an example simulation environment for a ride-sharing driver, it may be determined that the driver is occupied or free to pick up passengers. This may be verified on system 100 against a test at any point in time, and the verification may be continuously executed during the testing. Real user input, in this example, may include the driver refusing to pick up a passenger, even if free to do so.

In some examples, the system controller 104 may execute a particular configuration of events in a system under test simulated by the created simulation environment and verify a particular result in the system in response to the particular configuration of events. With respect to the configuration of events, a plurality of environmental states affect the plurality of functional agents 116, and an event (e.g., a change of these environmental states) may not be part of a test. For instance, in a ride sharing example, a hazard on the road in a particular area of the city is an event that changes an environmental state (e.g., which roads are open), which affects the system under test, and how it deploys ride requests to drivers.

In some examples, system 100 includes a system under test 114 executed by the system controller 104. The system under test 114 may be a system under test for correct operation. In an example, the system under test 114 is an application such as a ride sharing application or a navigational application. The system under test 114 may also be a part of the Internet of Things, in some examples.

When testing the system under test 114 using functional testing with load conditions in accordance with the present disclosure, a plurality of functional agents 116 may be initiated or “ramped up” to simulate real input sources of the system under test 114. The plurality of functional agents 116 represent a plurality of types of input behaviors including sensor input, and as noted, they may run continuously instead of sequentially, as in other approaches. The continuous running is in accordance with the functional testing with load conditions running without a pre-ordained start/stop time.

The plurality of functional agents may respond to events outside of their immediate interaction with an interface of the system under test 114 (e.g., react to conditions imposed by controller 104). The plurality of functional agents 116 may also include capabilities including being configurable by testers, ramping up in volume to create load conditions, capturing and reporting on their status and the system under test status, etc.

System 100 may include a repository of functional agent templates 106. For instance, a functional agent may be conformant with an agent-type template, which may be predefined by functional testing with load conditions (e.g., “user” type, “time-series sensor” type, “logical sensor” type, “environment” type, etc.) or by functional testing with load conditions administration (e.g., custom-made templates). The functional agent templates may determine attributes and configurations of the plurality of functional agents 116, such as the type of events to which a functional agent is subscribed within functional testing with load conditions. In some examples, attributes may be configured, actions may be assigned to events, randomness may be assigned to actions, and patterns of functional agent ramp-up may be defined.

Put another way, the plurality of functional agents 116 may be customized versions of a generic behavior. In such an example, the functional agent template repository 106 may include templates for human functional agents, sensor functional agents, etc.

System 100 running functional testing with load conditions may be equipped with the aforementioned functional agent template repository 106, which may enable testers to design a set of functional agents for a test, and may include functional agents simulating common sensors and common user behavior. For example, functional agent template repository 106 may include functional agent templates that enable a user when defining a test to pick and set a number of templates and scale them by number. In such an example, a human functional agent template may be selected, and there may be a generic behavior customized for a specific situation. Customization may include, for instance, telling system 100 to ramp up X instances of a customized template. The functional agent template repository 106 may include templates predefined by system 100 and/or additional administrator-defined templates. In some examples a marketplace of templates may be available.

In some instances, system 100 may include a data store 102 coupled to the functional agents 116. The data store 102 may be internal and/or external. For example, a functional agent within the plurality of functional agents 116 may use a data store (e.g., internal or external) as part of its action. The data store 102 may be configured to be local or global to the type of functional agent, to be pre-populated or populated as part of the actions, and/or to be linked to an external source. For instance, a temperature agent may use a link to public repositories of climate data of specified locale, in order to generate hourly temperatures.

FIG. 2 is a block diagram of an example system 201 for simulation environment creation consistent with the present disclosure. The system 201 may include a system controller 220 and a plurality of functional agents 224-1, 224-2, . . . , 224-n (referred to collectively herein as 224). The system 201 may also include, in some examples, a functional agent repository 222, and a plurality of data stores 226-1, 226-2, . . . , 226-m (referred to collectively herein as 226), and in some examples, a system under test (not illustrated in FIG. 2). The system 201 may include additional or fewer components than illustrated to perform the various operations as will be described in further detail in connection with FIG. 3.

The components of system 201 may include a combination of hardware and programming, but at least hardware, that is configured to perform operations described herein stored in a memory resource (e.g., computer-readable medium, machine-readable medium, etc.) as well as hard-wired program (e.g., logic). For example, the system controller 220 may include hardware and/or a combination of hardware and programming, but at least hardware, to execute the plurality of functional agents 224.

Repository 222 may include a plurality of functional agent templates, each of which determines attributes and configurations of the plurality of functional agents 224. The plurality of functional agents 224, as illustrated in FIG. 2, may be in communication with (e.g., coupled to) the repository 222 and may be executed by the system controller 220. The plurality of functional agents 224 may be executed to continuously receive input data including real user data and sensor data and continuously check for fired events by the system controller 220 within an event loop (e.g., programming construct that waits for and dispatches events in the system 201).

For example, the plurality of functional agents 224 may be executed by system controller 220 when a system under test (e.g., using functional testing with load conditions) test is launched. The plurality of functional agents' 224 composition may be defined as part of the test configuration, in terms of types of functional agents, startup condition (including injected randomness), and their absolute or dependent volume (e.g., user functional agents may be 20 percent of overall functional agents at any point, or can be randomly transitioned between 50 and 300 agents at any point). System controller 220 may be responsible to create functional agents corresponding to test configuration and subsequently launch a startup event to which the plurality of functional agents may react. A launched agent may enter an event-loop, which may continuously check for fired events by system controller 220, may execute actions for subscribed events, and may manage functional agent access to a functional testing with load conditions environment (e.g., functional agent outputs, system controller application program interface, system under test, etc.)

The plurality of functional agents 224 may further be executed to create a simulation environment for testing applications using the functional agent templates and based on the continuously received input data and the fired events. In some examples, the plurality of functional agents 224 may be executed to continuously update the simulation environment in response to the continuously received input data and the newly fired events.

During a test run in the simulation environment, system controller 220 may fire additional events, based on functional agents firing events, system under test events, functional testing with load conditions, and/or a tester launching events to test a system under test reaction. System controller 220 may also maintain functional agent output stream (e.g., latest value) and invoke new functional agents of a particular functional agent type if/when existing functional agent volume is outside of the range defined by test configuration. System controller 220 may launch functional agent events to obtain functional agent state and functional agent system under test assessment, which may be based on built-in functional agent definitions and/or customized as part of a tester's functional agent configuration.

In some examples, the plurality of functional agents 224 may be executed to react to an event fired during simulation and react to conditions imposed by the system controller. For instance, an event fired based on real user or sensor input (e.g., traffic sensors showing heavy traffic) may be reacted to (e.g., rerouting of a navigational application), but a system controller condition (e.g., avoid tolls) may also be reacted to. In such an example, a reaction may include a change in route, while still avoiding tolls, even if a tollway is fastest.

In some examples, the plurality of functional 224 may be executed to execute actions for subscribed events within the fired events. In some examples, a tester may stop the functional testing with load conditions test, upon which system controller 220 may fire a finalize event to the plurality of functional agents 224, which may be implemented by built-in functional agent definitions and/or by a tester's agent configuration to finalized functional agents' resources, assessment of system under test, and status. In response to the finalization, the functional agent event loop may exit, ending execution of the functional agent. In some examples, the final status of the plurality of functional agents 224 may be determined as the final status of its verifications.

In some examples, the plurality of functional agents 224 may be executed to manage access to the simulation environment. For instance, the plurality of functional agents may allow or disallow access by data stores, external media, etc. to the simulation environment. By doing so, control and consistency may be maintained.

The plurality of data stores 226 may be internal data stores and may be in communication with (e.g., coupled to) the plurality of functional agents 224, such that each of the plurality of functional agents 224 is in communication with a different internal data store.

FIG. 3 illustrates an example method 330 for simulation environment creation consistent with the present disclosure. While not illustrated in FIG. 3, the method 330 may begin when a user initiates a system (e.g., system 100 and system 201) and sets the system up for a functional load test. The user may specify the type and number of functional agents that may be used during the functional load scenario, and provide scripts for each of the autonomous agents. As described herein, the user may also establish constraints and dependencies among agents, and define the system under test environment.

At 332, method 330 may include capturing a plurality of behaviors of a system. The plurality of behaviors may include, for instance, real user input and sensor input. The real user input may include unpredictable human behavior (e.g., human reaction to GPS, human reaction to requests for rides on ride sharing applications, etc.) and the sensor input may include more predictable sensor-gathered behavior (e.g., weather sensors, traffic cameras, etc.)

At 333, method 330 may include configuring simulation conditions as a function of time for a simulation environment. For example, simulation conditions may be applied in the simulation environment from the start, while some may be initiated by the system controller later in the simulation by a time-based trigger (or by manual intervention.

At 331, method 330 may include configuring a plurality of functional agents based on templated functional agents for the simulation environment. The plurality of functional agents may each be a configuration of events and actions tied to the events, a functional agent type used to generate discrete functional agent instances, and state-bound verifications. The verifications may be unique for the purpose of functional tests, while the functional agent type and/or the functional testing with load conditions test configuration may be a mechanism that allows for load conditions based on ramping up a plurality of functional agents. The plurality of functional agents may retain differentiated behaviors even as the number of functional agents rises.

At 334, method 330 may include creating the simulation environment for the system based on the captured behaviors, configured simulation conditions, and configured plurality of functional agents. By considering these elements, different behaviors may be created in the simulation environment, while allowing for synchronization of everything happening in the simulation environment. In some examples, creating a simulation environment may include continuously simulating system behavior, continuously simulating real user behavior, and continuously simulating sensor behavior.

For instance, functional agents within the plurality of functional agents associated with sensor data may have script to create inputs for the system or create outputs for the system, but they are constantly running. As such, there may be constant instructions on how to continuously create those input/output flows instead of only from start to finish. For instance, is a sensor is utilized to simulate a thermometer, the sensor may continuously report on a temperature of the environment. It does not stop, but rather has a cycle of reporting temperatures that simulate real-world conditions.

Method 330, at 336 may include diagnosing the plurality of behaviors within the simulation environment. Diagnosing the plurality of behaviors may include continuously receiving input data from a plurality of sources, reacting to events triggered within the simulation environment based on the continuously received input data, and diagnosing the plurality of behaviors based on the reactions.

At 338, method 330 may include determining an experienced behavior of the system based on the diagnoses within the simulation environment. With a single-agent functional test, stem-under-test behavior may be “diagnosed” by a single result to a single action. In contrast, examples of the present disclosure include each functional agent diagnosing a specific result (e.g., success/failure), but also aggregating these results, which may include taking additional considerations into account (e.g. the simulation conditions) and deciding if the system-under-test behavior is OK.

For example, in a ride-sharing example, diagnosis may include capturing at a given point of time (in the simulation) all the current states of driver functional agents and passenger functional agents, as well as their history up until the point of success/failure rate, and the current conditions in the simulation (e.g., traffic load, road availability, passenger to driver ratio etc.). The diagnosis may be automatically used to compare to expected behavior and determine system-under-test failure/success (e.g. if the ratio of passengers/drivers is 3:1 and there are more than 20% of passengers not getting a driver within 10 minutes, the system has ‘failed’).

Method 330, at 340, may include verifying the experienced behavior. In some examples, functional agent verifications may be rules not tied to events, but may be evaluated at a schedule determined by the functional agent configuration. The verifications may evaluate the functional agent and system under test state and report pass/fail/unknown status. A functional test with load conditions may collect functional agents' status as a list of their verification status. Functional testing with load conditions may also allow binding of a functional agent verification status to a general test status in some examples (e.g., fail a test when specific verifications fail).

Method 330, in some examples, may include continuous interaction with the system, and the system may be a system under test. For instance, inputs of different types may be continuously received at the system, the simulation environment may be continuously updated, and verification of elements of the system may be made continuously, among others.

In some examples, method 330 may be performed using a system. For instance, the system may include a computing device that is capable of communicating with a remote system. The system may include a processor 222 and a machine-readable storage medium 224. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

The processor may be a central processing unit (CPU), microprocessor, and/or other hardware device suitable for retrieval and execution of instructions stored in the machine-readable storage medium. In example, the processor may receive, determine, and send instructions for simulation environment creation. As an alternative or in addition to retrieving and executing instructions, the processor may include an electronic circuit comprising a number of electronic components for performing the operations of the instructions in machine-readable storage medium.

The machine-readable storage medium may be any electronic, magnetic, optical, or other physical storage device that stores executable instructions. Thus, the machine-readable storage medium may be, for example, Random Access Memory (RAM), an Electrically-Erasable Programmable Read-Only Memory (EEPROM), a storage drive, an optical disc, and the like. The machine-readable storage medium may be disposed within the system. In this situation, the executable instructions may be “installed” on the system. The machine-readable storage medium may be a portable, extemal or remote storage medium, for example, that allows the system to download the instructions from the portable/external/remote storage medium. In this situation, the executable instructions may be part of an “installation package”. As described herein, the machine-readable storage medium may be encoded with executable instructions for simulation environment creation. The machine-readable instructions, when executed by the processor, may cause the system perform a plurality of functions, including those associated with method 330.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. The designators can represent the same or different numbers of the particular features. Further, as used herein, “a number of” an element and/or feature can refer to one or more of such elements and/or features.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

What is claimed:

1. A system for simulation environment creation, comprising:
a system controller; and
a functional agent coupled to and executed by the system controller to:
create a simulation environment based on input comprising real user data and sensor data continuously received from a plurality of sources;
perform tests within the simulation environment;
continuously react to events occurring during the tests within the simulation environment; and
continuously verify results of the tests.

2. The system of claim 1, further comprising a system under test with functional testing with load conditions, wherein the system under test is executed by the system controller.

3. The system of claim 1, wherein the system controller further executes a particular configuration of events in the system and verifies a particular result in the system in response to the particular configuration of events.

4. The system of claim 1, further comprising a repository of functional agent templates, the templates to determine attributes and configurations of the functional agent.

5. The system of claim 1, wherein the functional agent comprises particular action conditions, script actions, and visual actions.

6. The system of claim 1, further comprising an internal data store coupled to the functional agent.

7. A system for simulation environment creation, comprising:
a repository comprising a plurality of functional agent templates, each of the plurality of functional agent templates to determine attributes and configurations of a plurality of functional agents;
a plurality of functional agents coupled to the repository and executed by a system controller to:
continuously receive input data including real user data and sensor data;
continuously check for fired events by the system controller within an event loop; and
create a simulation environment for testing applications using the functional agent templates and based on the continuously received input data and the fired events; and
a plurality of internal data stores coupled to the plurality of functional agents, such that each functional agent is coupled to a different internal data store.

8. The system of claim 7, the plurality of functional agents executed by the system controller to continuously update the simulation environment in response to the continuously received input data and the newly fired events.

9. The system of claim 7, the plurality of functional agents executed by the system controller to:
react to an event fired during simulation; and
react to conditions imposed by the system controller.

10. The system of claim 7, the plurality of functional agents executed by the system controller to execute actions for subscribed events within the fired events.

11. The system of claim 7, the plurality of functional agents executed by the system controller to manage access to the simulation environment.

12. A method for simulation environment creation, comprising:
capturing a plurality of behaviors of a system;
creating a simulation environment for the system based on the captured behaviors;
diagnosing the plurality of behaviors within the simulation environment;
determining an experienced behavior of the system based on the diagnoses within the simulation environment; and
verifying the experienced behavior.

13. The method of claim 12, wherein creating the simulation environment comprises iteratively:
simulating system behavior,
simulating real user behavior, and
simulating sensor behavior.

14. The method of claim 12, further comprising continuously interacting with the system, wherein the system is a system under test.

15. The method of claim 12, wherein diagnosing the plurality of behaviors comprises:
continuously receiving input data from a plurality of sources;
reacting to events triggered within the simulation environment based on the continuously received input data; and
diagnosing the plurality of behaviors based on the reactions.
